(19) United States
(12) Patent Application Publication
(10) Pub. No.: US 2015/0274081 A1
(43) Pub. Date: Oct. 1, 2015

(54) FIXING DEVICE FOR USE IN A VEHICLE

(71) Applicant: Eagle FAN, Hsinchu (TW)

(72) Inventor: Eagle FAN, Hsinchu (TW)

(21) Appl. No.: 14/242,256

(22) Filed: Apr. 1, 2014

(51) Int. Cl. B60R 7/04; B60R 11/02

(52) U.S. Cl. CPC B60R 7/04; B60R 11/02

(57) ABSTRACT

A fixing device for use in a vehicle, includes a holder having a power outlet consisting of at least one electric socket and a USB port, and further having two opposite holding surfaces; a clamping member mounted on one holding surface of the holder for clamping a head support of a vehicle seat in such a manner that the holder is fixed securely on the head-support; a position altering member mounted on the other holding surface of the holder; and a coupler member coupled adjustably to the positioning altering member, and having at least one tenon adapted to engage a mortise of an attaching article, thereby installing the article on the coupler member.

### BACKGROUND OF THE INVENTION

1. Field of the Invention

The present invention relates to a fixing device for use in a vehicle, more particularly to a fixing device having a design serving as a connection platform and consisting of a power outlet.

2. The Prior Arts

Motor vehicles are prevalent and serve as public transportation devices for majority of public. So does an electronic device (like tablet computers and smart phones), which a person brings along with him whenever he or she goes out. It is noticed that using an electronic device while one is driving a vehicle is dangerous. However, if a traveling person can use an electronic device while he is traveling in a vehicle is welcome, since no time waste is resulted and to prevent from getting bored, he can do some job with the assistance of the electronic device.

As the portable electronic device gets bigger in size and in function features, liking viewing videos, play games and surfing the Internet, the power runs out more quickly. In case of long time use of the portable electronic device, the time for re-charging the power becomes shorter. If a passenger seated on the rear seat of a vehicle uses the electronic device, he may encounter difficulties since the rear seat are not provided with the power outlet. Hence, the present invention is intended to develop a product for solving the above-stated problem.

### SUMMARY OF THE INVENTION

Therefore, the objective of the present invention is to provide a fixing device for use in a vehicle. The fixing device is mounted securely on a head support of a vehicle seat and simultaneously serves as a connection platform and power supply, such that the head support of the vehicle seat in the vehicle installed with the fixing device of the present invention is provided with a power outlet. Hence, the passenger seated at the rear seat of the vehicle can comfortably use the electronic device without encountering the problem of power run out.

Another object of the present invention is to provide a fixing device for use in a vehicle. The fixing device accordingly includes a holder having a power outlet consisting of at least one electric socket and a USB port, the holder further having two opposite holding surfaces; a clamping member mounted on one holding surface of the holder for clamping the posts of the head support in a vehicle seat in such a manner that the holder is fixed securely on the head support of the vehicle seat; a position altering member mounted on the other holding surface of the holder; and a coupler member coupled adjustably to the positioning altering member such that adjustment of the position altering member results in a relative position change of the coupler member with respect to the holder, the coupler member having at least one tenon adapted to engage a mortise of an attaching article, thereby installing the article on the coupler member.

Another object of the present invention is to provide a fixing device, in a simpler way, for use in a vehicle. The fixing device accordingly includes a holder having a power outlet consisting of at least one electric socket and a USB port, the holder further having two opposite holding surfaces; a clamping member mounted on one holding surface of the holder for clamping a head support of a vehicle seat in such a manner that the holder is fixed securely on the head support of the vehicle seat; a position altering member mounted on the other holding surface of the holder; and a coupler member coupled adjustably to the positioning altering member, and having at least one tenon adapted to engage a mortise of an attaching article, thereby installing the article on the coupler member.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view of the first embodiment of a fixing device of the present invention for use in a vehicle;

FIG. 2 shows a perspective view of the first embodiment of the fixing device of the present invention for use in a vehicle in a different viewing angle;

FIG. 3 shows a perspective view of the first embodiment of the fixing device of the present invention applied in a vehicle;

FIG. 4 shows a perspective view of the second embodiment of the fixing device of the present invention for use in a vehicle;

FIG. 5 shows a perspective view of the third embodiment of the fixing device of the present invention for use in a vehicle; and

FIG. 6 shows a perspective view of the fourth embodiment of the fixing device of the present invention for use in a vehicle.

### DETAILED DESCRIPTION OF THE PREFERRED EMBODIMENTS

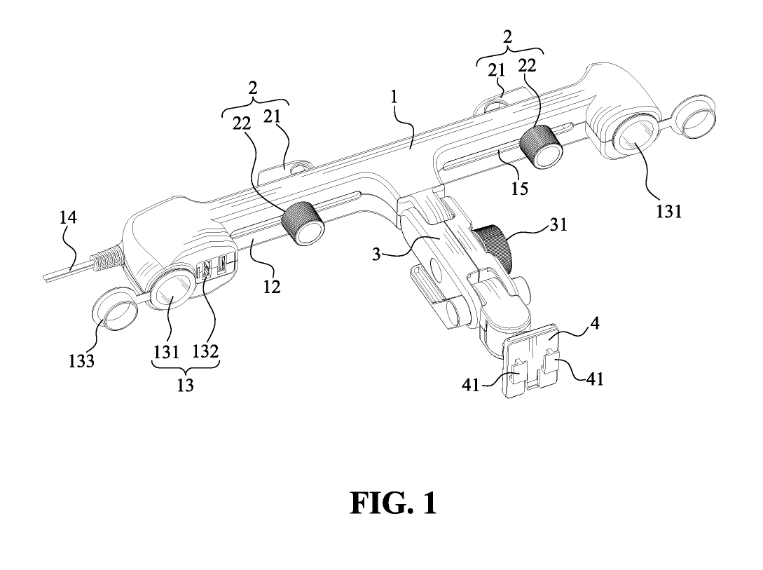

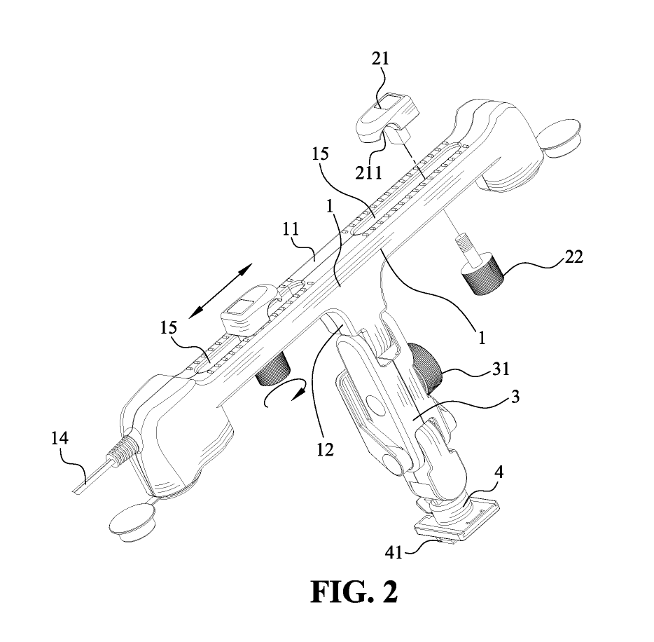

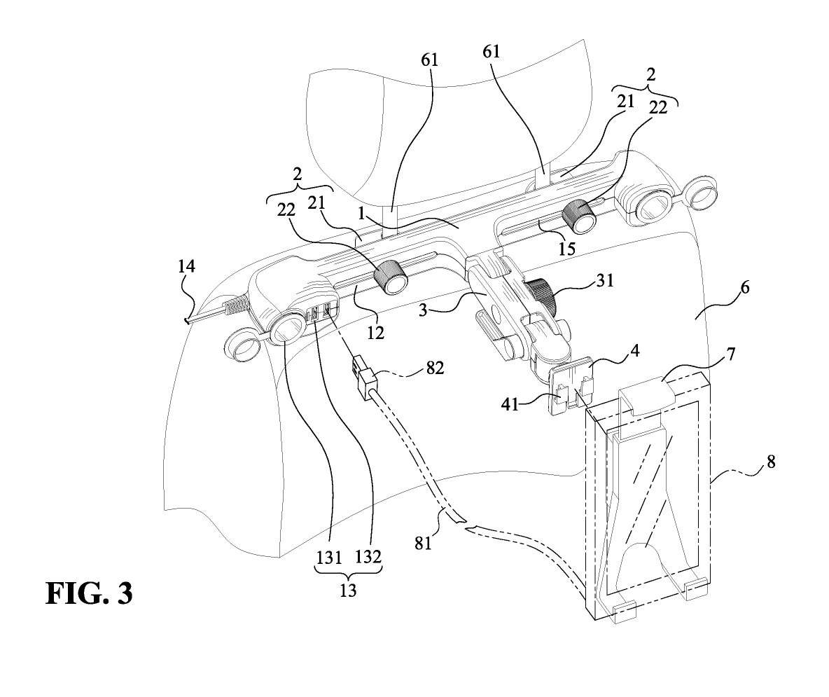

Referring to FIGS. 1 to 3, wherein FIG. 1 shows a perspective view of the first embodiment of a fixing device of the present invention for use in a vehicle; FIG. 2 shows a perspective view of the first embodiment of the fixing device of the present invention for use in a vehicle in a different viewing angle; and FIG. 3 shows a perspective view of the first embodiment of the fixing device of the present invention applied in a vehicle. As illustrated, the fixing device of the present invention includes a holder 1, a clamping member 2, a position altering member 3 and a coupler member 4.

The holder 1 in fact is an elongated hollow body having two opposite holding surfaces 11, 12, includes a power outlet 13 consisting of at least one electric socket 131 and a USB port 132. In this embodiment, there are one electric socket 131 and one USB port 132. Preferably, the electric socket 131 has a configuration of a cigarette lighter socket in a vehicle and is provided with a protection cap 133 for shielding the socket 131 when not in use so to prevent waste from getting interior of the socket 131. The electric socket 131 is provided at one of the holding surfaces 11, 12 and is coupled electrically with a power cable 14 (consisting of circuit board) of the vehicle. The electric socket 131 and the USB port 132 are electrically coupled to each other and are supplied power by the power cable 14.

The clamping member 2 is mounted on one holding surface of the holder 1 for clamping the posts of a head support of a vehicle seat in such a manner that the holder 1 is fixed securely on the head support of the vehicle seat. Since the head support in one vehicle seat differs from another vehicle seat, only one type of the head support is used herein for illustration of the present invention, and the structure thereof should not be limited only to the disclosure. The clamping member 2 further includes a clamp piece 21 and a tightening element 22, which are connected threadedly relative to each other in order to clamp an article securely therebetween. The holder 1 is formed with an elongated sliding slot 15 to permit sliding of the clamp piece 21 and the tightening element 22 therein. The clamp piece 21 has a clamping notch 211 at one side thereof so that tightening of the tightening element 22 relative to the clamp piece 21 results in mounting of the holder 1 on the head support of the vehicle seat.

The position altering member 3 is mounted on the other holding surface 12 of the holder 1. In this embodiment, the position altering member 3 has one front end connected pivotally to the other holding surface 12 of the holder 1 and a rear end connected adjustably to the coupler member 4 such that adjustment of the position altering member 3 results in a relative position change of the coupler member 4 with respect to the holder 1. Preferably, the position altering member 3 is provided with a rotary knob 31, tightening and loosening action of the same relative the main body can adjust relative position between the position altering member 3 and the coupler member 4.

The coupler member 4 is used for holding an article (not visible) thereon, like a TV, such that the TV will be hanged on the head support of the vehicle seat. In this embodiment, the coupler member 4 has at least one tenon 41 of T-shaped constituted by two separated pieces to engage a mortise of an attaching TV, thereby installing the TV on the coupler member 4.

As best shown in FIG. 3, for installing the fixing device of the present invention on a vehicle seat, two clamp pieces 21 are hooked around two posts 61 of the head support of the vehicle seat and the clamp pieces 21 respectively and securely clamp the posts 61 upon tightening of the tightening elements 22 relative to the clamp pieces 21. A holding member 7 holding an electronic device (TV) 8 thereon and defining a mortise is slidably inserted into the tenon 41 on the coupler member 4, thereby finishing installation of the electronic device 8 on the coupler member 4. In case, the electronic device 8 encounters power run out, the power can be re-charged by simply plugging the plug of the connecting cable 81 into the USB port 132 of the holder 1, hence providing facilitation to the user of the electronic device 8.

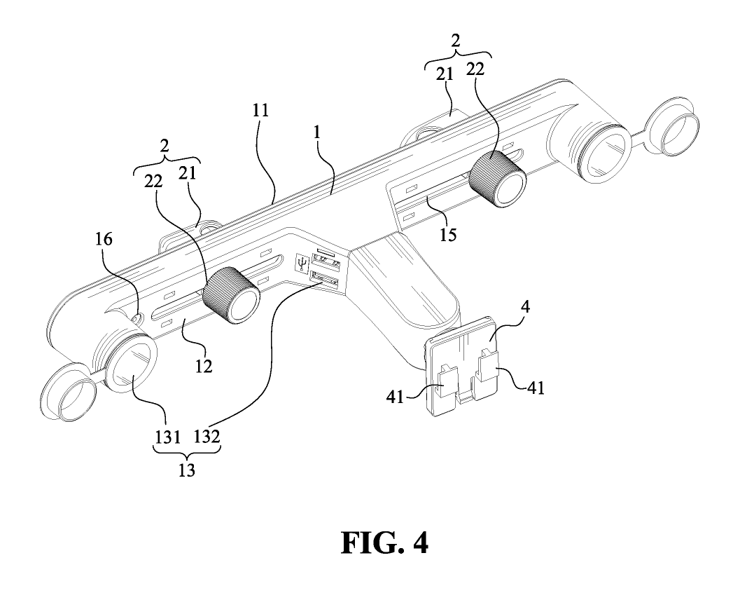

FIG. 4 shows a perspective view of the second embodiment of the fixing device of the present invention for use in a vehicle. The second embodiment has a structure similar to the first embodiment, except that no position altering member is implemented in the second embodiment. The coupler member 4 is mounted on the rear mounting surface 12 of the holder 1. The USB port 132 of the holder 1 of the second embodiment is differed in position compared to the first embodiment. In the second embodiment, the USB ports 132 are formed at the middle section while the main body is further provided with a power socket 16 for connection with an external power source for supplying electrical power to the fixing device of the present invention.

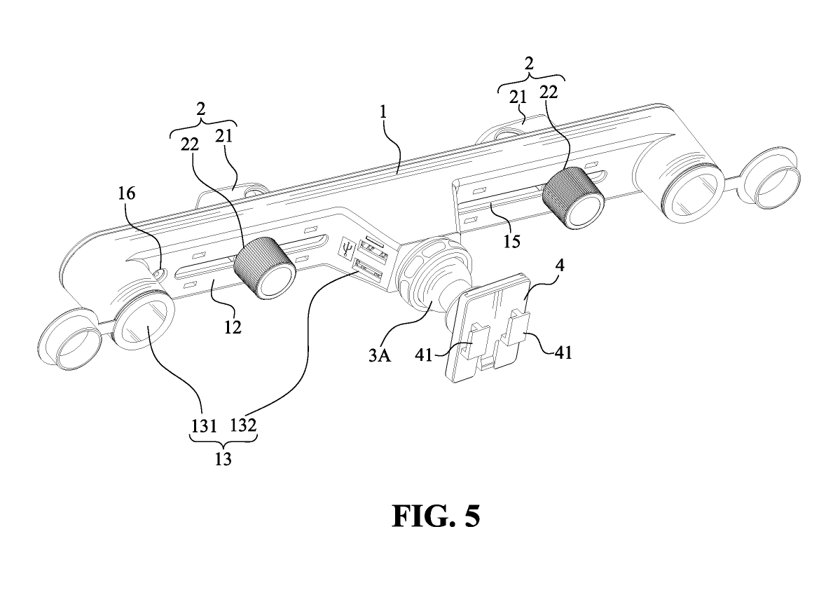

FIG. 5 shows a perspective view of the third embodiment of the fixing device of the present invention for use in a vehicle. The third embodiment has the structure similar to the first embodiment, except that the position altering member 3A is a ball-type structure but providing the same function.

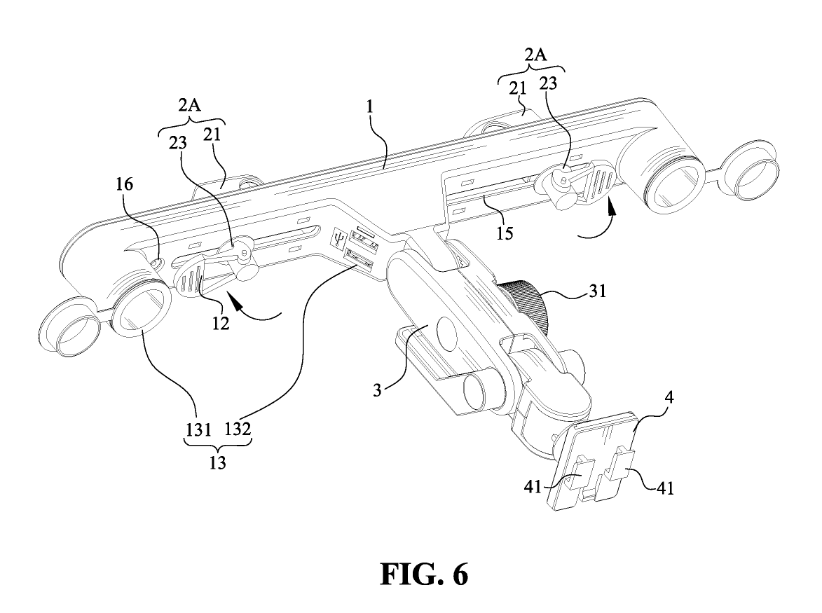

FIG. 6 shows a perspective view of the fourth embodiment of the fixing device of the present invention for use in a vehicle. The fourth embodiment has the structure similar to the first embodiment, except that the clamping member 2A is constituted by two clamping pieces 21 and two press tabs 23 connected to the clamping pieces 21 in such a manner that pressing of the tabs 23 toward the holder 1 results in tightening action of the clamping pieces 21 relative to the head support of the vehicle seat (not visible) and vice versa.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fixing device for use in a vehicle, comprising:
a holder including a power outlet consisting of at least one electric socket and a USB port, said holder further having two opposite holding surfaces;
a clamping member mounted on one holding surface of said holder for clamping a head support of a vehicle seat in such a manner that the holder is fixed securely on the head support of the vehicle seat;
a position altering member mounted on the other holding surface of said holder; and
a coupler member coupled adjustably to said positioning altering member such that adjustment of said position altering member results in a relative position change of said coupler member with respect to the holder, said coupler member having at least one tenon adapted to engage a mortise of an attaching article, thereby installing the article on the coupler member.

2. A fixing device for use in a vehicle, comprising:
a holder including a power outlet consisting of at least one electric socket and a USB port, said holder further having two opposite holding surfaces;
a clamping member mounted on one holding surface of said holder for clamping a head support of a vehicle seat in such a manner that the holder is fixed securely on the head-support of the vehicle seat;
a position altering member mounted on the other holding surface of said holder; and
a coupler member coupled adjustably to said positioning altering member, and having at least one tenon adapted to engage a mortise of an attaching article, thereby installing the article on the coupler member.
